(19) United States
(12) Patent Application Publication
(10) Pub. No.: US 2009/0096186 A1
(43) Pub. Date: Apr. 16, 2009

(54) WOODEN TUBULAR FRAMES

(76) Inventors: Kenneth A. Wheeler, Portland, OR (US); Stuart E. Wheeler, Portland, OR (US)

Correspondence Address: MARGER JOHNSON & MCCOLLOM, P.C., 210 SW MORRISON STREET, SUITE 400, PORTLAND, OR, 97204, US

(21) Appl. No.: 12/252,059

(22) Filed: Oct. 15, 2008

Related U.S. Application Data
(60) Provisional application No. 60/980,401, filed on Oct. 16, 2007.

(51) Int. Cl. B62K 19/14; B21D 53/86

(52) U.S. Cl. 280/281.1; 29/897.2

(57) ABSTRACT

A frame and method of forming a frame. The frame includes a first part formed of wood; a second part formed of wood. The first part and the second part are bonded together forming a space between first part and the second part, and providing structural support for the frame.

### CROSS-REFERENCE TO RELATED APPLICATIONS

This application claims priority under 35 U.S.C. §119(e) from U.S. Provisional Application Ser. No. 60/980,401 filed Oct. 16, 2007, titled WOODEN TUBULAR FRAMES, the contents of which are herein incorporated by reference in their entirety.

### BACKGROUND

This disclosure relates to tubular frames and, in particular, to wooden tubular frames.

Bicycle frames are predominantly made from materials such as steel, aluminum and carbon fiber. Though traditional and relatively easy to manufacture, frames made of these materials have several weaknesses.

Many metal frames are made of butted tubing which has a very thin wall for most of the tube length to make the tube lightweight, and a much thicker wall at the ends for strength and to facilitate welding at the joints. The thinner sections of these tubes can be easily dented. Even a minor dent can render the frame unsuitable to ride, as stated in a leading manufacturer's owner's manual, ‘Do not ride a bicycle or component with any crack, bulge or dent, even a small one.’ Furthermore, metal frames are subject to corrosion, and in the case of aluminum specifically, galvanic corrosion in the presence of carbon fiber or aluminum components. Both steel and aluminum frames are subject to stress cracking and even the smallest dent can result in stress cracks. Such cracks can quickly propagate, and do so more quickly if corrosion is present. Finally, the ride qualities of these frame materials can be undesirably harsh or sharp when the frames are made stiff enough for many bicycling activities, due to the proportionality of strength and stiffness in these materials.

The use of carbon fiber has produced frames that are generally lighter than aluminum or steel. Carbon fiber also cracks due to stress. However, carbon fiber is also very susceptible to cracks propagating from scratches or chips, which, as a leading manufacturer of both aluminum and carbon fiber bicycles states in the owner's manual, “Significant scratches, gouges, dents or scoring create starting points for cracks,’ ‘If you find a crack, replace the part’, and ‘Riding a cracked frame, fork or component could lead to complete failure, with risk of injury or death.’ In addition to cracking, hidden delamination of carbon fiber parts is a serious problem. The largest of the manufacturers cautions ‘Damaged carbon fiber can fail suddenly. Carbon fiber can conceal damage from an impact or crash.’ They provide a separate web page, and an online movie entitled Composite Part Inspection which shows bicycle owners how to inspect their bikes for damage and how to test for hidden delamination. With steel, aluminum and carbon fiber frames, a typical carbon fiber and aluminum bicycle manufacturer's caution is ‘Once a crack starts, it can grow, and grow fast. If you find a crack, replace the part.’

The problems with these materials could be eliminated by simply making the frames of thicker walled tubing, but such a bicycle would be unacceptably heavy.

Wood as a frame material has characteristics which can avoid the problems stated above, and solid wood frames have been built, but they also are too heavy. So wood has been generally ignored and even discouraged as a bicycle frame material:

‘Indeed, whenever an I-beam or tube construction is selected to carry tension and bending only, wood is a fine choice. Unfortunately, the tubes that make up bicycle frames are also subjected to torsion, and with no helical fibers, a wood rod or tube would be absolutely unacceptable as regards strength or stiffness.’

Bicycling Science, 3^{rd} Ed. p. 378, (ISBN 0-262-73154-1).

Accordingly, there remains a need for an improved bicycle frame.

### BRIEF DESCRIPTION OF THE DRAWINGS

FIG. 1 is an illustration of the formation of a wooden tube according to an embodiment.

FIG. 2 is an illustration of a bicycle frame using wooden tubes of FIG. 1.

FIG. 3 illustrates a plank with wooden blanks before the wooden blanks are cut from the plank according to an embodiment.

FIG. 4 illustrates a plan view and side view of the wooden blanks of FIG. 3 assembled into a frame blank.

FIG. 5 is a cross-sectional view of the frame blank of FIG. 4 at various stages of machining.

FIG. 6 illustrates an internal webbing in a frame half according to an embodiment.

FIG. 7 illustrates a side view of a frame half according to an embodiment.

FIG. 8 illustrates two frame halves prior to assembly according to an embodiment.

FIG. 9 illustrates an assembled frame and inserts according to an embodiment.

FIG. 10 illustrates an example of wooden blanks of FIG. 3 according to an embodiment.

FIG. 11 illustrates an example of a frame blank formed from wooden blanks of FIG. 10 with an outline of a desired frame half.

### DETAILED DESCRIPTION

Wood can be formed into hollow tubes or monocoque frames which can be made into, for example, the frames of bicycles or wheelchairs. Wood has several advantages over metal or carbon fiber composite frames. Wood is approximately one quarter the density of aluminum which can result in a lighter frame. Wood has superior vibration damping, which, in a bicycle for example, results in a smoother ride. Wood is extremely impact tolerant, enabling it to withstand impacts which would ruin frames of other materials. Wood has the property of stopping crack propagation, as observed in wooden posts and beams in old buildings, and it will not propagate a crack from a scratch or dent like aluminum, carbon fiber and titanium. Wood is highly resistant to stress concentration, so that inserting fasteners has little effect on mechanical properties. The work of fracture for wood is as high as ductile steel.

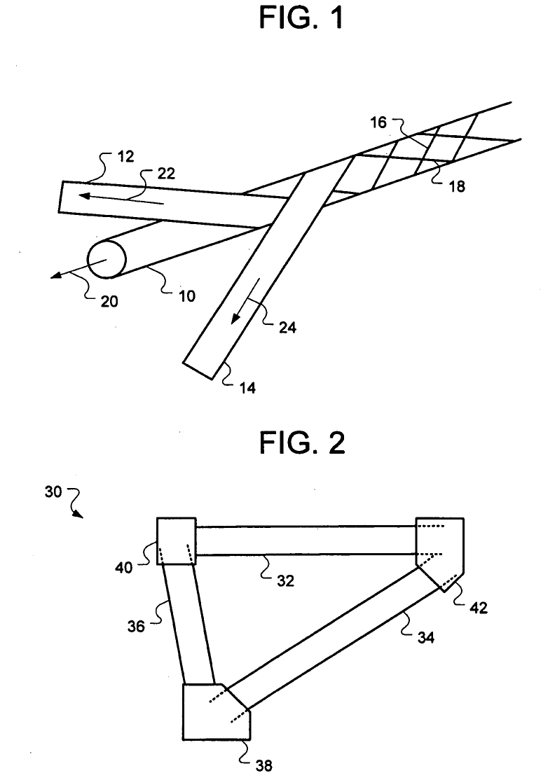

FIG. 1 is an illustration of the formation of a wooden tube according to an embodiment. Wooden strips 12 and 14 are wrapped around mandrel 10. Strips 12 and 14 are aligned at angles relative to each other. In one embodiment, strips 12 and 14 are aligned to be at about 90 degrees relative to each other. In addition, each strip 12 and 14 can be aligned to be about 45 degrees off from axis 20 of the mandrel 10. In an embodiment, strips 12 and 14 can be at +45 degrees and −45 degrees off of axis 20, respectively.

Wooden strips 12 and 14 can be successively laid over the mandrel 10. For example, wooden strip 12 can be wound over the mandrel in a counter-clockwise direction. In an embodiment, the wooden strip 12 can be wound around the mandrel 10 such that edges of the wooden strip 12 abut one another. That is, the edges of the wooden strip 12 do not overlap. Region 18 indicates a location where edges of the wooden strip 12 abut one another. Similarly, wooden strip 14 can be wound around the mandrel 10 such that the edges of the wooden strip 14 abut one another as shown in region 16. In this example, wooden strip 14 is wound clockwise around mandrel 10.

When winding the wooden strips 12 and 14 around the mandrel 10, tension can be applied to the strips. Accordingly, the wooden strips 12 and 14 form tight contact with any previously wound strips.

In addition to wooden strips 12 and 14, additional wooden strips (not shown) can be placed longitudinally along the mandrel 10. For example, strips of wood can be placed following the axis 20 of the mandrel 10. Accordingly, wooden strips can be wound around the mandrel 10 offset from the axis 20 by any angle.

An adhesive can be used to hold the wooden strips 12 and 14 in place. Examples of such adhesive can include epoxy, PVA, or the like. The adhesive is cured. Accordingly, the wooden strips formed over the mandrel 10 retain their shape after the mandrel 10 is removed. As a result, the laminated wooden strips form a hollow wooden tube.

In an embodiment, the grain of the wood selected for the strips can run substantially in the same direction as the strip. For example, arrows 22 and 24 indicate the directions of the grain for wooden strips 12 and 14, respectively. In addition, the grain of a longitudinal wooden strip can be substantially parallel to the axis 20. Accordingly, once the wooden tube is formed, the grains of the various wooden strips are aligned to resist forces that are placed on the tube. For example, wooden strips with grain aligned to along the axis 20 can resist bending. Wooden strips 12 and 14, for example, can resist torsion on the tube. In one example, wooden strip 12 can resist torsion in a first direction about axis 20 and wooden strip 14 can resist torsion in a second direction about axis 20.

Furthermore, as grains that are aligned in different directions provide resistance to various forces, the number and directions of the wooden strips used to form the wooden tube can be selected as desired to achieve the desired physical properties of the application of the wooden tube. For example, if a greater resistance to torsion is desired, additional wooden strips such as wooden strips 12 and 14 can be used.

The wooden strips can have a variety of thicknesses. In an embodiment, the wooden strips can be from about 0.005″ to about 0.020″. A finished wooden tube can have a thickness of about 0.190″. Accordingly, multiple strips can be overlaid to form the finished wooden tube. Although particular ranges of thicknesses for the strips and the finished tube have been given, the dimensions can be changed as desired. For example, thicker strips can be used when making a thicker finished tube. Thinner strips can be used when using a mandrel with a complex shape. Furthermore, the thickness of strips can vary within a given wooden tube.

Although the mandrel 10 has been illustrated as cylindrical, the mandrel 10 can take a variety of shapes. In an embodiment, the mandrel can have any shape such that the wooden strips can conform to the mandrel. In an embodiment, the mandrel can have a polygonal cross-section. The edges of the mandrel corresponding to the corners of the polygon can be selected to have radii such that wooden strips applied to the mandrel can conform to the mandrel without tearing.

FIG. 2 is an illustration of a bicycle frame using wooden tubes of FIG. 1. The bicycle frame 30 includes top tube 32, down tube 34, and seat tube 36. Top tube 32 and seat tube 36 are joined by a connector 40. Top tube 32 and down tube 34 are joined by connector 42. Down tube 34 and seat tube 36 are joined by connector 38.

The connectors 38, 40, and 42 can be formed from a variety of materials. For example, the connectors 38, 40, and 42 can be formed from machined wood, molded metal, or the like. Any technique of capturing the ends of the respective tubes can be used for the connectors 38, 40, and 42.

The bicycle frame 30 gives an example of tubes with different physical requirements. For example, seat tube 36 may encounter increased bending forces, but relatively reduced torsion. Accordingly, seat tube 36 can have additional longitudinal strips. In contrast, down tube 34 may encounter more torsion than seat tube 36. Accordingly, down tube 34 can be formed with additional crossed strips such as wooden strips 12 and 14 of FIG. 1.

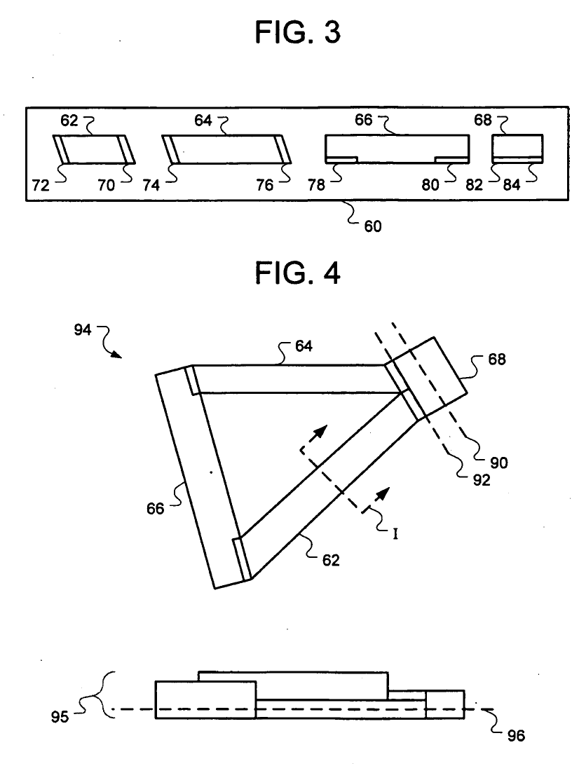

FIG. 3 illustrates a plank with wooden blanks before the wooden blanks are cut from the plank according to an embodiment. In an embodiment, a monocoque wooden frame can be formed from wooden blanks. The plank 60 can be any size and/or shape of wood. The plank can be a solid piece of wood. In another embodiment, the plank 60 can be a laminate formed of multiple layers of wood. In an embodiment, the grains of the wood are all substantially aligned in one direction. For example, the grain of the wood can be aligned in substantially the same direction of arrow 88. In another embodiment, the wood can be a laminate formed with the grains of the component sheets in a variety of directions.

In the embodiment illustrated in FIG. 3, wooden blanks 62, 64, 66, and 68 are arranged in a line on the plank. The plank 60 can, but need not have dimensions such that the wooden blanks 62, 64, 66, and 68 can only be laid out in a line. For example, the plank 60 can have different dimensions such that the wooden blanks 62, 64, 66, and 68 can be laid out in more than one direction.

In an embodiment, the wooden blanks 62, 64, 66, and 68 correspond to different portions of a bicycle frame. Wooden blank 62 corresponds to the down tube, wooden blank 64 corresponds to the top tube, wooden blank 66 corresponds to the seat tube, and wooden blank 68 corresponds to the HT. If the grain of the wood is aligned with arrow 88, then the grain of the wood is aligned accordingly in the wooden blanks 62, 64, 66, and 68.

Each of the wooden blanks 62, 64, 66, and 68 can be finger jointed where the wooden blank will be joined with other wooden blanks. For example, wooden blank 62 has finger joints at regions 70 and 72 corresponding to where the wooden blank 62 can be joined to wooden blanks 68 and 66, respectively. Wooden blank 64 has finger joints at regions 74 and 76 corresponding to where the wooden blank 64 can be joined to wooden blanks 66 and 68, respectively. Wooden blank 66 has finger joints at regions 78 and 80 corresponding to where the wooden blank 66 can be joined to wooden blanks 62 and 64, respectively. Wooden blank 68 has finger joints at regions 82 and 84 corresponding to where the wooden blank 68 can be joined to wooden blanks 64 and 62, respectively. In an embodiment, finger joints can be formed such that when the wooden blanks are assembled into a frame, the individual fingers are aligned in the direction of a force expected to be applied to the joint.

Although finger joints have been described, other joints can be used. For example, a biscuit joint, a dovetail joint, a mortise and tenon joint, a tongue and groove joint, a dowel joint, or the like can be used.

The wooden blanks 62, 64, 66, and 68 can be cut from the plank 60. Any technique of cutting can be used. Although not illustrated, the wooden blanks 62, 64, 66, and 68 can remain attached to the plank 60 through breakable tabs. Accordingly, the wooden blanks 62, 64, 66, and 68 can remain in the remainder of the plank 60 for ease of manufacturing. Once cut from the plank 60, the wooden blanks 62, 64, 66, and 68 can be routed, notched, slotted, or the like to form the desired joint in the desired location.

FIG. 4 illustrates a plan view and side view of the wooden blanks 62, 64, 66, and 68 assembled into a frame blank. The wooden blanks 62, 64, 66, and 68 can be joined together by the joints described above to form frame blank 94. Although the wooden blanks 62, 64, 66, and 68 have been defined by the joints between tubes in a frame, the actual joint can be placed in different locations. As illustrated, wooden blank 62 and 64 extend into wooden blank 68 to a plane 92. However, in another embodiment, wooden blanks 62 and 64 can extend into wooden blank 68 to plane 90. Any position along the frame blank can have a location for a joint.

In an embodiment, once assembled, the frame blank 94 may be coplanar. Accordingly, the frame blank 94 can be planarized to a plane 96. For example, the frame blank 94 can be sanded down to plane 96. In another example, a plane can be used to form the surface of plane 96. For example, a thickness of the plank 60 can be selected such that the frame blank 94 is greater than about 0.050″ in excess of the desired thickness of the finished frame half. Although a particular range has been given as an example, an amount of the additional material can be selected as desired. For example, the additional material can be a thickness sufficient to accommodate an expected variation in heights due to the placement of the joints. Accordingly, a substantially uniform surface at surface 96 can be formed on the frame blank 94. As will be described below, the substantially uniform surface can aid in bonding two frame blanks together.

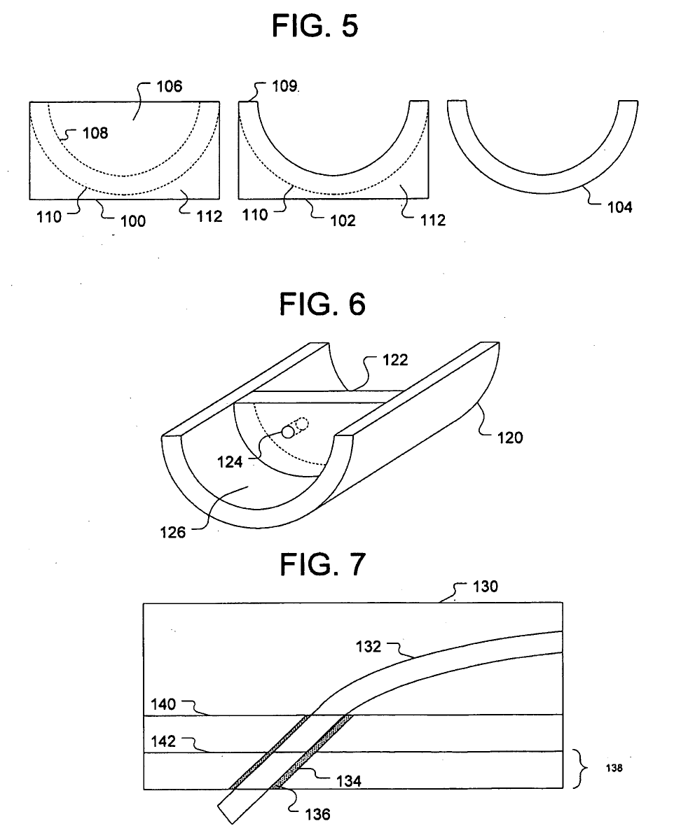

FIG. 5 is a cross-sectional view of the frame blank of FIG. 4 at various stages of machining. In an embodiment, at this point, the frame blank 94 is in a rough shape of one half of a finished frame. Cross-section 100 illustrates the frame blank 94 at plane I of FIG. 4. Dashed lines 108 and 110 represent the desired surfaces of the finished frame half. The frame blank 94 can be machined to form the desired shape. For example, the frame blank 94 can be loaded on to a computer-numerical-controlled (CNC) machine. Region 106 can be machined away to result in cross-section 102. Similarly, region 112 can be machined away to result in cross-section 104. As a result, the desired shape of the frame half can be machined from the frame blank. In an embodiment, the planarization to surface 96 of FIG. 4 can be performed by the machining described above.

In an embodiment, regions on the frame blank 94 similar to region 106 of FIG. 5 can be machined away in the same process. Once finished, the frame blank 94 can be flipped so that the opposite surface can be machined.

In an embodiment, during machining, the frame blank 94 can be secured to the CNC machine using vacuum. Once the material similar to region 106 has been removed, the frame blank 94 can be flipped and secured again with a vacuum. In an embodiment, the edge including surface 109 may be continuous around the removed region 106. Accordingly, when flipped, a vacuum can still be formed within the frame blank 94 to secure it to the CNC machine. Holes, openings, cutouts, slots, or the like can be formed in the before and after machining. To maintain the vacuum, such openings can be plugged for subsequent machining. In another embodiment the frame blank 94 can be secured to the CNC machine using a jig.

Although the term frame half has been used to describe portions of a frame, a frame half is not limited to half of a frame. For example, a frame half can be one of multiple parts that are machined and combined into a completed frame.

FIG. 6 illustrates an internal webbing in a frame half according to an embodiment. Frame half 120 has webbing 122 remaining in a machined region 126. The webbing 122 can be placed as desired throughout the frame half 120. A hole 124 can be formed in the webbing 122. Such a hole 124 can be used for a variety of purposes. For example, the hole 124 can be used for drainage, cable routing, or the like. Although the internal webbing has been illustrated in the frame half 120, in an embodiment, the frame half 120 need not have any webbing.

FIG. 7 illustrates a side view of a frame half according to an embodiment. Cables can be routed through the frame blank 130. In this embodiment, the frame blank 94 has been machined to remove material to form surface 140. Surface 142 has not yet been formed through machining. Before forming surface 142, a hole 134 can be formed in the frame blank 130. A tube 132 can be inserted into the hole 134. Although not illustrated, the tube 132 can also extend through another hole in the frame blank 130. The tube 132 is secured in the hole 134 with an adhesive, epoxy, filler, or the like.

The frame blank 130 is then machined to remove material in region 138. During the machining, a portion of the tube 132 and the adhesive 136 within region 138 are machined. As a result, the opening of the tube is substantially coplanar with the surface 142. In this embodiment, since the tube passed through the hole 134 at an angle offset from perpendicular to the surface 142, any cable entering or exiting the hole can also be at such an angle relative to the surface 142.

In an embodiment, the adhesive 136 and the tube 132 seal the hole 134. Accordingly, any vacuum applied to the frame blank 130 can still secure the frame blank for machining.

In an embodiment, surfaces of the frame half can be coated with a waterproofing layer. All surfaces of the frame half can, but need not be coated with waterproofing. For example, only the inner surface can be coated with waterproofing.

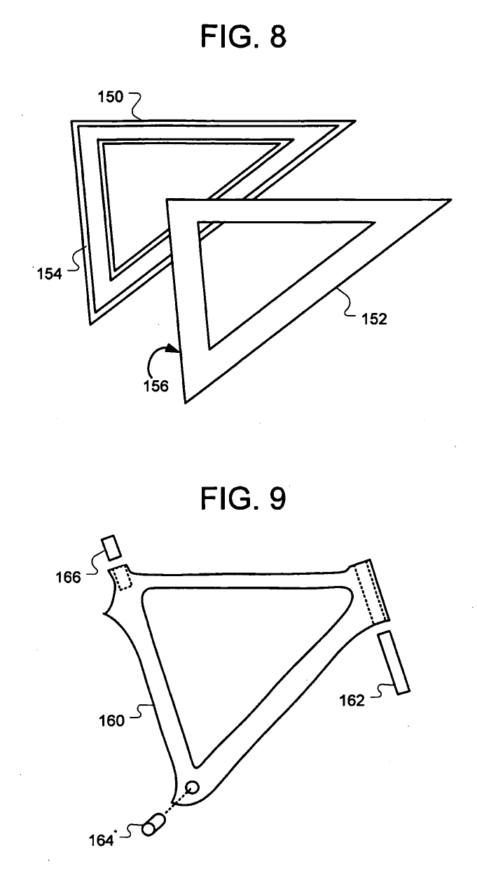

FIG. 8 illustrates two frame halves prior to assembly according to an embodiment. First frame half 150 and second frame half 152 can be joined together to for a frame. First frame half 150 has a surface 154. Second frame half has a surface 156. An adhesive can be applied to one or both of the surface 154 and surface 156. The adhesive can, but need not be continuous on the surface to which it is applied. Although a surface 154 around the perimeter of the first frame half 150 has been illustrated, the surface 154 can include surfaces of other structures of the first frame half 150. For example, as described above, webbing may be within a frame half. Accordingly, the adhesive can be applied to a surface of the webbing. Adhesive can be applied to any surface of a frame half that will contact a corresponding surface of the another frame half.

The first frame half 150 and the second frame half 152 can be brought together so that the adhesive joins the two halves together. Although not illustrated, a frame half can have alignment structures to aid in aligning the first frame half 150 to the second frame half 152. For example, the first frame half 150 can have dowels places around the first frame half 150. The second frame half 152 can have corresponding holes for the dowels. In another example, a groove, notch, slot, or the like can be machined into the surface 154. A corresponding mating structure can be machined in surface 156. In an embodiment, the alignment structures can be formed in the webbing described above.

FIG. 9 illustrates an assembled frame and inserts according to an embodiment. In an embodiment, frame 160 is a bicycle frame. Inserts 162, 164, and 166 can be inserted into the frame 160. For example, insert 162 can be a stem tube insert. Insert 164 can be a crank insert. Insert 166 can be a seat tube insert. An insert can be used in any location where something is mounted or in contact with the frame 160. The inserts 162, 164, and 166 can be secured in a variety of ways. For example, the inserts can be secured by friction, adhesive, mechanical detents, fasteners, or any other mechanical capturing technique.

Although the inserts 162, 164, and 166 have been described as being inserted into the frame 160, the inserts can be assembled with the frame halves as described above, For example, the inserts 162, 164, and 166 can be assembled with the first frame half 150. During assembly with the second frame half 152, the inserts 162, 164, and 166 can be secured between the first and second frame halves 150 and 152.

Once assembled, the frame 160 can be used as would any other bicycle frame. For example, a crank can be inserted through insert 164, a stem can be inserted through insert 162, and a seat can be inserted through insert 166. In addition, a rear triangle can be attached to the frame 160. Since the frame 160 can be used as any other frame, any type of rear triangle can be used. For example, rear triangles formed from steel, aluminum, carbon composite, or the like can be used. Furthermore, a rear triangle can be formed from wood as described above.

By using wood in such structures, the quality of the ride can be tailored to the rider. For example, a 200 lb. rider may need a stiffer quality than a 95 lb. rider. Accordingly, wood species, grain orientation, wood strip orientation, or the like can be modified separately, or in combination to achieve desired characteristics.

Any variety of wood can be used as desired. Wood species can be selected based on a variety of characteristics. For example, wood can be selected based on its machinability, grain density, straightness, impact resistance, or the like. Furthermore, the same wood species can, but need not be used throughout a single frame. For example, wood species selected for strength can be used in internal portions of the frame, while wood species selected for aesthetics can be used as an outer lamination or veneer.

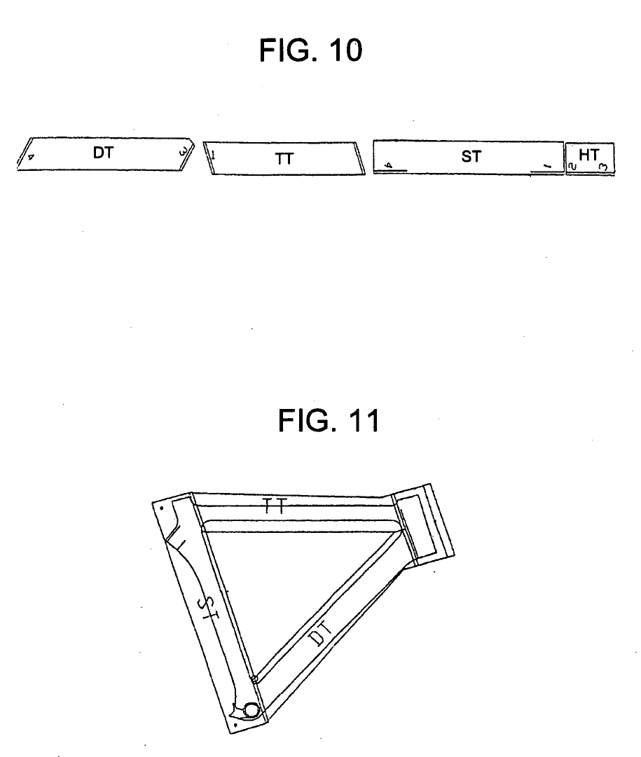

FIG. 10 illustrates an example of wooden blanks of FIG. 3 according to an embodiment. Numbers 1-4 illustrate the corresponding surfaces. FIG. 11 illustrates an example of a frame blank formed from wooden blanks of FIG. 10 with an outline of a desired frame half.

Having described and illustrated the principles of the invention in a preferred embodiment thereof, it should be apparent that the invention can be modified in arrangement and detail without departing from such principles. Accordingly, all modifications and variations coming within the spirit and scope of the above disclosure are included.

1. A frame, comprising:
a first part formed of wood; and
a second part formed of wood;
wherein the first part and the second part are bonded together forming a space between first part and the second part, and providing structural support for the frame.

2. The frame of claim 1, the first part further comprises:
a concave opening; and
webbing within the concave opening.

3. The frame of claim 1, further comprising:
an opening between the first part and the second part; and
an insert disposed in the opening.

4. The frame of claim 1, wherein the first part is formed from laminated wood.

5. The frame of claim 4, wherein at least two sheets of the laminated wood have grain directions that are different.

6. The frame of claim 1, wherein:
the first part includes a first half of a top tube, a seat tube, and a bottom tube of the frame; and
the second part includes a second half of a top tube, a seat tube, and a bottom tube of the frame.

7. The frame of claim 1, wherein the first part further comprises:
a first frame half part;
a second frame half part attached to the first frame half part at a first joint;
a third frame half part attached to the second frame half part at a second joint; and
a fourth frame half part attached to the first frame half part and the third frame half part at a third joint and a fourth joint, respectively.

8. The frame of claim 7, wherein at least one of the first through fourth joints includes at least one of a biscuit joint, a dovetail joint, a mortise and tenon joint, a tongue and groove joint, and a dowel joint.

9. The frame of claim 1, wherein the first part and second part form a main triangle of a bicycle frame.

10. The frame of claim 1, further comprising a rear triangle coupled to the main triangle.

11. A structure, comprising:
a plurality of wood strips; and
an adhesive binding the wood strips to each other;
wherein the bonded strips of wood form a hollow structure.

12. The structure of claim 11, wherein:
each wood strip has a grain direction; and
the grain directions of the wood strips are in substantially the same direction relative to the corresponding wood strip.

13. The structure of claim 1 1, wherein a grain direction of a first wood strip of the wood strips is different from a grain direction of a second wood strip of the wood strips.

14. The structure of claim 11, the wood strips, adhesive, and hollow structure referred to as first wood strips, a first adhesive and a first hollow structure, the structure further comprising:
a plurality of second wood strips;
a second adhesive binding the second wood strips to each other, forming a second hollow structure;
a plurality of third wood strips;
a third adhesive binding the third wood strips to each other, forming a third hollow structure;
a first connector connecting the first hollow structure to the second hollow structure;
a second connector connecting the second hollow structure to the third hollow structure; and
a third connector connecting the first hollow structure to the third hollow structure.

15. The structure of claim 14, wherein grain directions of wood strips of at least two of the first, second, and third hollow structures are different between the at least two of the first, second, and third hollow structures.

16. A method of forming a frame, comprising:
forming a first part and a second part from corresponding wooden blanks; and
bonding the first part to the second part to form an opening between the first part and the second part.

17. The method of claim 16, further comprising laminating wood sheets to form the wooden blanks.

18. The method of claim 16, further comprising:
machining a first set of wooden blanks;
machining a second set of wooden blanks;
joining the first set of wooden blanks to each other; and
joining the second set of wooden blanks to each other;
wherein the first set of wooden blanks form the first part and the second set of wooden blanks form the second part.

19. The method of claim 18, further comprising machining the first set of wooden blanks after joining the first set of wooden blanks to each other.

20. The method of claim 16, further comprising:
machining a substantially planar first surface on the first part;
machining a substantially planar second surface on the second part; and
bonding the first surface to the second surface.
